(19) United States
(12) Patent Application Publication
(10) Pub. No.: US 2006/0182006 A1
(43) Pub. Date: Aug. 17, 2006

(54) Optical record carrier with ase active material, reading device and method for reading such optical record carrier

(75) Inventors: Marcello Leonardo Mario Balistreri, Eindhoven (NL); Christopher Busch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/565,148

(22) PCT Filed: Jul. 12, 2004
(86) PCT No.: PCT/IB04/51189

§ 371 Date: Jan. 19, 2006

(30) Foreign Application Priority Data
Jul. 22, 2003 (EP) 03102252.8

(51) Int. Cl. G11B 7/24

(52) U.S. Cl. 369/275.1; 369/283

(57) ABSTRACT

The present invention relates to an optical record carrier (1) for recording information readable by means of an optical beam (L). It is an object of the invention to improve the collection efficiency of the information carrier (1). The object is achieved by the optical record carrier (1) comprising at least one information layer (P1) containing material showing amplified spontaneous emission (ASE) when stimulated by said optical beam (L) having an intensity above an ASE-excitation intensity threshold. The invention also relates to a reading device and a method for reading information from an optical record carrier with ASE material.

The present invention relates to an optical record carrier for recording information readable by means of an optical beam. The invention further concerns a reading device for reading information from an optical record carrier. The invention also relates to a method for reading information from an optical record carrier.

There is a growing demand in reliable record carriers of digital information for computers, video systems, multimedia etc. Such record carriers should have high capacity. Currently required storage capacities make the use of three dimensional (3D) storing necessary. In this technology a plurality of information layers is stacked upon each other in a disc. In multi-layer discs information layers have to be addressed and selected for recording and reading.

Current multi-layer technologies, as for instance known from U.S. Pat. No. 6,009,065, use fluorescent material as storage material. Information layers are separated by thick spacer layers. Layers can be addressed for recording/reading by focusing a recording/reading laser beam on it. Selectivity for recording is achieved by the recording laser beam intensity at the focal spot being much higher than in the non-addressed layers, thereby heating up only the desired spot above a threshold temperature and degrading the fluorescent material to fluorescent inactive material.

Reading an addressed layer can be achieved by focusing the reading laser beam on it. 3D optical data reading by one focused reading laser beam is inevitably followed by fluorescence of a large number of fluorescent sections from non addressed layers confined within the conical surface of the focused reading laser beam. Read out selectivity can be achieved by use of confocal detection. A pinhole in front of the collector/detector or a small collector/detector is used to detect only the fluorescent emitted light from the addressed layer and not from non addressed layers.

Fluorescent emission can be detected by collectors above and/or below the disc. A disadvantage of the described multi-layer technology is the low collection efficiency of the isotropic emission. For an objective lens with NA=0.6 the collection efficiency of a fluorescent multi-layer optical information carrier is around 4%.

It is therefore an object of the present invention to provide an optical record carrier having a higher collection efficiency. It is further an object of the invention to provide a simple reading device and a corresponding method with higher collection efficiency.

This object is achieved according to the present invention by an optical record carrier for recording information readable by means of an optical beam and comprising at least one information layer containing material showing amplified spontaneous emission (ASE) when stimulated by said optical beam having an intensity above an ASE-excitation intensity threshold.

The present invention is based on the idea to use material emitting non-isotropic emission being stimulated by an optical beam. Non-isotropic emission can be collected more efficiently by an appropriate read-out device, thus the collection efficiency is improved and reading out is facilitated. According to the invention material emitting amplified spontaneous emission (ASE) being stimulated by the optical beam is contained in the at least one information layer. Light emitted from the ASE material is highly directional along the optical beam direction in the forward and backward direction and can be collected above and below a plain optical record carrier, e.g. a disc. Advantageously, the detection of the pulses of emitted light is facilitated, because such pulses have a narrow spectral width, resulting in less achromatic aberrations.

A multi-layer record carrier contains at least two, but usually a plurality, of stacked information layers. To decrease the background noise from non addressed layers and to isolate the information layers thermally, they are separated by spacer layers. Each information layer contains tracks in which information is encoded by an alternating sequence of ASE active and ASE inactive sections. ASE active material is fluorescent. According to a preferred embodiment of the invention, it is not the fluorescent properties of the ASE active material, but its ASE properties that are used for reading stored information.

For reading a multi-layer record carrier an optical beam is focused on an addressed layer in order to stimulate the ASE active material therein. Thus, stacked information layers having a high storage capacity can be read-out. To let the optical beam reach the addressed layer without high losses the spacer layer is transparent for the optical beam. Additionally, the spacer layer is transparent for the light emitted from the ASE material. Thus, the emitted light can cross the layers and can be detected by at least one detecting means.

Compared to fluorescence ASE occurs at higher excitation intensity thresholds (called ASE-excitation intensity thresholds here). In principal all fluorescent organic and inorganic materials can be used as ASE active material. Until now it was not considered to use ASE active material as storage material in optical record carriers because the excitation intensity thresholds are that high that no corresponding read-out devices with appropriate optical beam intensities were commercially available.

Surprisingly it was found out that certain materials have low ASE-excitation intensity thresholds and recent developments of optical beam sources lead to cheap lasers with higher intensities.

In a preferred embodiment of the invention the ASE active material contains dye. The dye can be a conventional lasing dye, which is lasing with and without cavities. A possible lasing dye is PM 597. Another dye is APSS. These dyes are relatively easily available.

ASE active materials with a low excitation intensity threshold are DNA and dye. Recently it was found out that DNA lowers the excitation energy threshold for conventional laser dyes but also for dyes in general (Applied Physics Letters, Vol. 81, No. 8, 2002). A concrete example for such a dye is DMASDPB. Thus, optical beams with lower intensities and a larger variety of dyes can be used to gain ASE.

ASE active material can be used in ROM and WORM technologies. In ROM implementations pre-embossed pits in each information layer are filled with ASE active material. In WORM implementations pre-embossed grooves encircling e.g. the disc in each information layer concentrically can be filled with ASE active material. Sections in the grooves are heated above a threshold temperature such that the material looses its ASE characteristic. It reverts to a permanent ASE inactive state.

The object of the invention is further achieved by a reading device for reading information from an optical record carrier comprising at least one information layer containing material showing amplified spontaneous emission (ASE) when stimulated by an optical beam, comprising a light source for emitting the optical beam to be directed onto said at least one information layer, said optical beam having an intensity above an ASE-excitation intensity threshold; and detecting means for detecting mainly light emitted by said ASE-material.

To read the information from the optical record carrier an optical beam, preferably a laser beam, is directed onto the optical record carrier, which can be put in an appropriate drive of the device. Intensity of the optical beam (excitation beam) is above the intensity an ASE excitation intensity threshold in a focal spot.

The intensity of the unfocussed optical beam is generally not high enough to stimulate ASE. Means for focusing the optical beam are provided to focus the beam on a focal spot on an in-focus layer. Only the intensity in the focal spot is above the ASE-excitation intensity threshold. This reduces background noises from out-of-focus layers not being stimulated to show ASE.

In current read-out devices red laser diodes with low intensities are used. Surprisingly, it was found out that recently developed pulsed blue laser diodes have a sufficient high intensity to stimulate ASE active material described above.

Light emitted from an ASE material can be detected by a detecting means. Detecting means may comprise for example a detector and a filter. The filter has high transparency for light having wavelength corresponding to wavelength of the light emitted from the ASE material and low transparency for light having different wavelength. Consequently, light detected by such detecting means is mainly the light emitted from the ASE material. Light having different wavelength (especially the light of the excitation beam) is filtered out to large extent.

In a preferred embodiment the reading device comprises first detecting means for detecting backward ASE and second detecting means for detecting forward ASE. Said reading device detects nearly 100% of the light emitted from an ASE material. Reliable detecting means can comprise objective lenses. The signals to be detected are stronger, and background noise is reduced compared to the described prior art.

The object is also achieved by a corresponding method for reading optical information from an optical record carrier as claimed in claim 11.

The invention will now be explained in more detail with reference to the drawings, in which:

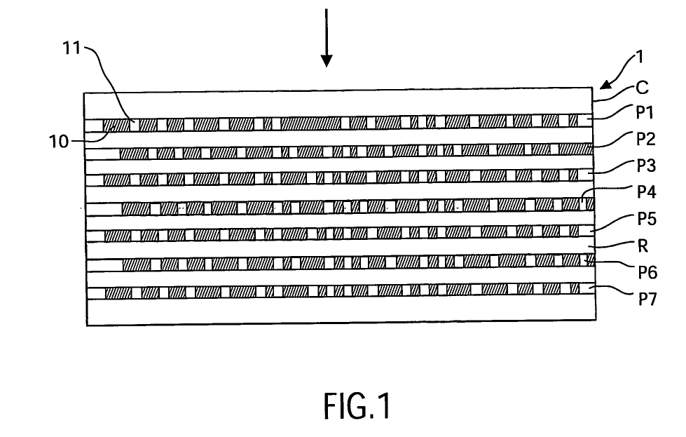

FIG. 1 shows a cross-section of an optical record carrier according to the present invention,

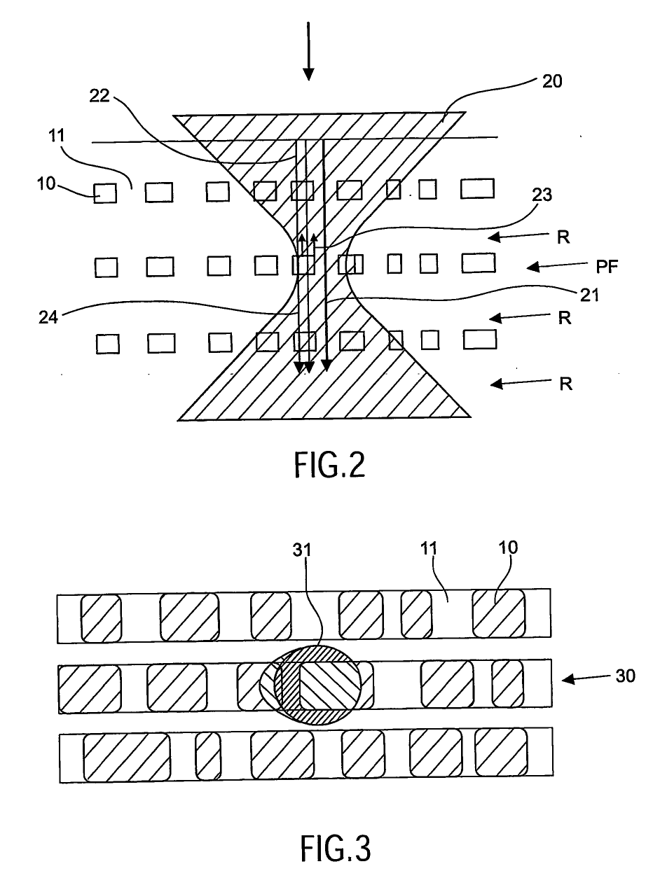

FIG. 2 shows a side-view of said optical record carrier with a focused laser beam on an in-focus layer,

FIG. 3 shows a top-view of the in-focus layer in FIG. 2,

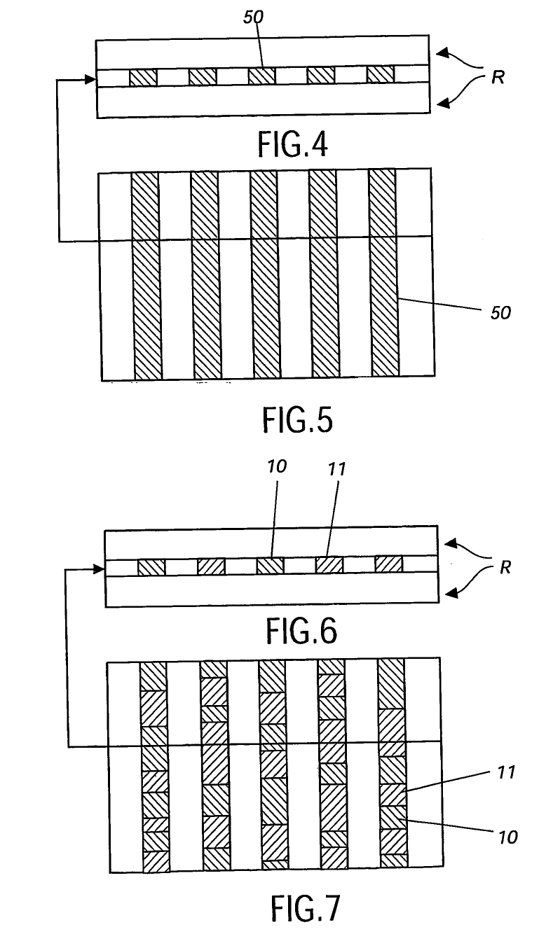

FIG. 4 shows a side-view of a recording-layer,

FIG. 5 shows a top-view of the recording-layer in FIG. 4,

FIG. 6 shows a side-view of a recorded layer,

FIG. 7 shows a top-view of the recorded layer in FIG. 6,

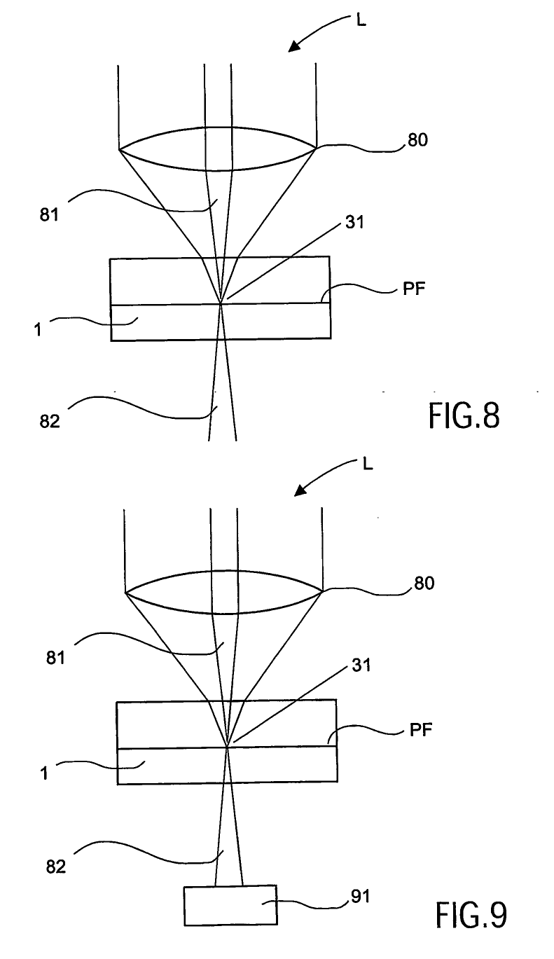

FIG. 8 shows a schematic view of a first reading device,

FIG. 9 shows a schematic view of a second reading device,

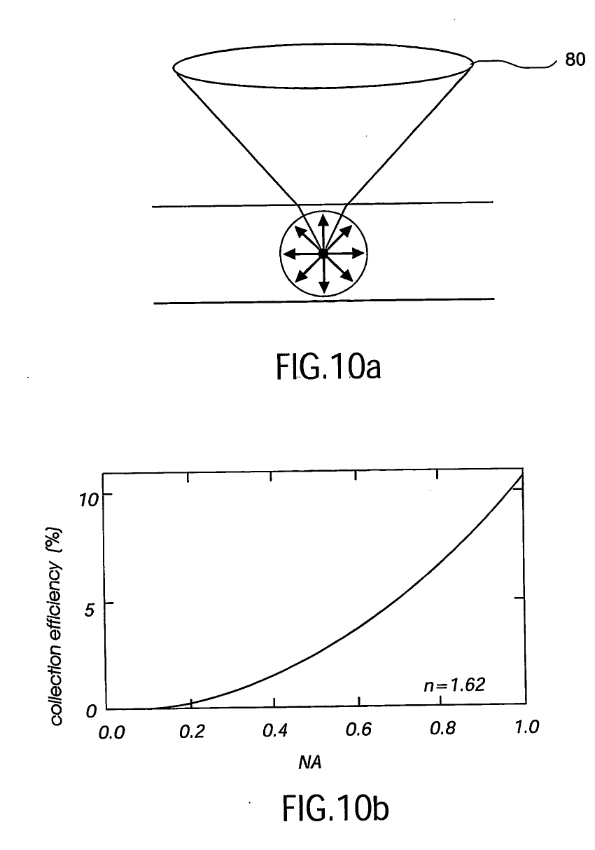

FIG. 10a illustrates isotropic emission in an record carrier according to the prior art, and

FIG. 10b shows collection efficiency as a function of detecting NA for isotropic emission according to FIG. 10a.

FIG. 1 shows a first embodiment of a multi-layer optical record carrier according to the present invention in form of a disc 1. An incident side of the disc is covered with a cover layer C transparent for light emitted from the ASE material and an optical beam. The incident direction of the optical reading beam, e.g. a laser beam or light generated by LEDs is indicated by an arrow L. The shown disc comprises seven stacked information layers P1 to P7. The information layers P1 to P7 are recorded and separated by spacer layers R to thermally separate adjacent information layers P1 to P7 from each other.

The disc 1 is formed by an alternating stack of optically inert spacer layers R and optically active information layers P1 to P7. The spacer layers R are optically inactive, i.e. they are transparent for the optical beam L and for light emitted from the ASE material in the information layers P1 to P7. The disc 1 shown in FIG. 1 is not properly scaled. The spacer layers R have a thickness of preferably between 1 and 100 μm, in particular between 5 and 30 μm. Information layers P1 to P7 have a thickness of preferably between 0.05 and 5 μm.

Each information layer P1 to P7 comprises sections 10 containing ASE active material (in FIG. 1 these sections 10 are hatched) and sections 11, which consist of ASE inactive material (in FIG. 1 these sections 11 are blank) within the information layers P1 to P7.

The principle of reading information from the disc 1 is illustrated in FIG. 2. FIG. 2 shows a cut-out of FIG. 1, namely three information layers separated by spacer layers R. The sequence of sections containing ASE active material 10 and sections containing ASE inactive material 11 of the information layers P1 to P3 is just accidentally identical. The reading beam L is focused on the second information layer PF, the in-focus layer. The focused laser beam L is shaped as a cone 20.

In this embodiment a blue Nichia laser diode is used. For a 35 pJ and 10 ns focused pulse a 4 MW/cm² intensity can be achieved by the Nichia laser diode using an 0.6 NA objective lens. In other embodiments a PicoQuant laser can be used. For a 10.5 pJ and 70 ps focused pulse a 150 W/cm² intensity can be achieved by said laser using a 0.6 NA objective lens.

For inducing ASE a laser intensity above an ASE-excitation intensity threshold is needed. ASE active material is fluorescent. Stimulating ASE active material by appropriate laser light results in an isotropic fluorescence. Increasing the laser intensity above the ASE-excitation intensity threshold, highly directional emission occurs additionally.

A first part 21 of the reading beam light crosses all layers P1 to P7 and R of the disc 1. A second part 22 of the reading beam light is absorbed by the ASE active material stored in the corresponding sections 10. The excited ASE-material emits semi-coherent light into a forward 24 and into a backward 23 directions parallel to the laser beam direction.

Examples of the ASE-materials are the organic chromophore 4-[N-(2-hydroxyethyl)-N-(methyl)amino phenyl]-4′-(6-hydroxy-hexyl sulphonyl) stilbene abbreviated APSS. A solution of APSS in dimethyl sulphoxide (DMSO) illuminated by 1.3 μm laser beam emits yellowish-green isotropic fluorescence. Increasing the laser intensity above a certain threshold, highly directional light of 0.55 μm is emitted from the ASE material into the forward and backward directions (Nature, Vol. 415, 14.2.2002, p. 767 ff.). Because excitation results from a 3-photon process the excitation intensity threshold I_{(excitation threshold)} ˜σ⁻¹ is high due to small absorption cross sections a for 3-photon processes.

A stimulating input pump pulse stimulates an ASE pulse. The ASE pulse emitted by APSS is delayed by 5-15 ps. But the pulse duration of the ASE pulse is longer (30-50 ps) compared to the duration of the pump pulse (150 fs). Advantageously the spectral width of the ASE pulse is much narrower (10 nm) compared to the spectral width of the fluorescent pulse (75 nm).

Sections 10 of the information layers P1 to P7 can also be filled with 1,3,5,7,8-pentamethyl-2,6-di-t-butylpyrromethene-difluoroborate complex (PM 597) as ASE active material. The excitation intensity threshold is about 340 W/cm² and the threshold energy is 5.5 μJ. ASE is around 573 nm (IEEE, Vol. 34, No. 3, March 1998).

In the described embodiment of the invention according to FIGS. 1, 2 and 3 dye-doped DNA is used as ASE-material. The dye is 4-[4-(dimethylamino) stylyl]-1-dococylpyridinium bromide (DMASDPB). The use of DNA decreases the lasing threshold of conventional laser dyes but also of other dyes as DMASDPB. The excitation intensity threshold is 0.06 W/cm² and the threshold energy is 20 μJ (Applied Physics Letters, Vol. 81, No. 8, 2002).

FIG. 3 shows the in-focus layer P2 of FIG. 2. The information is stored in the ASE active material distributed along tracks 30 concentrically encircling the disc. In each track 30 there is a sequence of sections with ASE active material 10 and with ASE inactive material 11. The laser beam is focused on the in-focus layer so that a focal spot 31 has a diameter of about the width of a single track 30. Exposing ASE active material sections 10 to the focal spot 31 results in light emitted from the ASE material propagating in the forward and backward direction. If the focal spot 31 is directed onto sections with ASE inactive material 11 ASE does not occur. The sequence of ASE and non-emission is detected and evaluated.

FIGS. 4 and 5 show a cut-out of an unrecorded WORM disc in a side (FIG. 4) and a top view (FIG. 5). Five parallel recording tracks 50 containing ASE active material are arranged in a recording layer sandwiched by two spacer layers R. A recoding layer is prepared by pre-embossing grooves into the disc material and filling these grooves with ASE active material. The tracks 50 in the recording layer are prepared to be recorded in a following step.

The result of recording information onto the WORM disc is shown in FIG. 6 and FIG. 7. Recording information in the unrecorded tracks 50 is carried out by means of a recording laser beam (not shown). The recording beam degrades predetermined sections of each track 50 by heating the predetermined sections. During this process the temperature in the heated section 11 becomes that high that the ASE material is degraded. The degraded material is and remains ASE inactive.

FIG. 8 shows a schematic view of a first reading device according to the invention. The disc 1 is properly scaled. The reading beam is focused by an adjustable objective lens 80 with a numerical aperture of 0.6. The disc 1 contains stacked information layers. The objective lens can be adjusted to focus the laser beam onto a predetermined in-focus layer PF and is focused on the in-focus layer PF. The excitation intensity threshold of the ASE active material is exceeded in the focal spot 31. Outside the focal spot 31 the reading beam intensity is too low to excite the ASE active material to show ASE. Backward light 81 emitted from the ASE material is supplied to an detecting means (not shown) through the objective lens 80. Forward light 82 emitted from the ASE material is not detected.

In a second embodiment of the reading device shown in FIG. 9 the backward 81 and forward 82 ASE emitted by the in-focus layer PF is detected. A detector 91 and filter (not shown) is provided at the laser beam rear-side of the disc 1 to detect the forward light emission. With this arrangement nearly all emitted light is collected.

FIG. 10a shows isotropic emission in a side-view according to the art. The incoming light is collected with an objective lens 80. In the case of fluorescent storage a severe disadvantage is the emission of light under a large solid angle. FIG. 10b shows the collected light as a measure for the collection efficiency as a function of the numerical aperture (NA) of the objective lens. The refractive index is n=1.62. The function shows clearly that even for a NA=1.0 only about 10% of the light emitted from the in-focus layer by isotropic emission can be collected. A normal reading device has NA=0.6 resulting in a collection efficiency of about 4%. The above described invention improves the collection efficiency. Theoretically, even nearly 100% of the backward and forward ASE can be collected.

The invention provides record carriers containing ASE active material. ASE is highly directional into a forward and backward direction. Thus, compared to fluorescent multi-layer record carriers emitting isotropic radiation the collection efficiency of an arrangement of reading device and record carrier can be improved considerably using ASE active material. Recently found materials containing DNA and dye have lower ASE-excitation intensity thresholds for ASE to be used in combination with pulsed blue laser diodes.

1. Optical record carrier (1) for recording information readable by means of an optical beam (L) and comprising at least one information layer (P1) containing material showing amplified spontaneous emission (ASE) when stimulated by said optical beam (L) having an intensity above an ASE-excitation intensity threshold.

2. Optical record carrier (1) as claimed in claim 1, characterized in that said material contains dye.

3. Optical record carrier (1) as claimed in claim 1, characterized in that said material contains DNA and dye.

4. Optical record carrier (1) as claimed in claim 2, characterized in that the dye contains 4-[4-(dimethylamino) stylyl]-1-dococylpyridinium bromide (DMASDPB).

5. Optical record carrier (1) as claimed in claim 2, characterized in that the dye contains 1,3,5,7,8-pentamethyl-2,6-di-t-butylpyrromethene-difluoroborate complex (PM 597).

6. Optical record carrier (1) as claimed in claim 2, characterized in that the dye contains 4-[N-(2-hydroxyethyl)-N-(methyl)amino phenyl]-4′-(6-hydroxy-hexyl sulphonyl) stilbene (APSS).

7. Optical record carrier as claimed in claim 1, characterized by at least two information layers (P1-P7) and at least one spacer layer R) separating said at least two information layers (P1-P7), said at least one spacer layer (R) being transparent for said optical beam (L) and light emitted by said material.

8. Reading device for reading information from an optical record carrier (1) comprising at least one information layer (P1) containing material showing amplified spontaneous emission (ASE) when stimulated by an optical beam (L), comprising:
a light source for emitting the optical beam (L) to be directed onto said at least one information layer (P1), said optical beam (L) having an intensity above an ASE-excitation intensity threshold, and
detecting means for detecting mainly light emitted by said ASE-material.

9. Reading device as claimed in claim 8, further comprising means for focusing (80) said optical beam (L) on said at least one information layer (P1) and having an intensity above said ASE excitation intensity threshold in a focal spot.

10. Reading device as claimed in claim 8, characterized by first detecting means (80) for detecting backward directional emission and second detecting means (91) for detecting forward directional emission.

11. Method for reading optical information from an optical record carrier (1) comprising at least one information layer (P1) containing material showing amplified spontaneous emission (ASE) when stimulated by an optical beam (L), comprising the steps of:
focusing the optical beam (L) onto said at least one information layer (P1) and generating an intensity in said at least one information layer (P1) above an ASE-excitation intensity threshold,
detecting mainly light emitted by said ASE material.
